(19) United States
(12) Patent Application Publication
(10) Pub. No.: US 2003/0034698 A1
(43) Pub. Date: Feb. 20, 2003

(54) Static generator

(76) Inventor: Eric Thomas Schmidt, Wichita, KS (US)

Correspondence Address: Eric T. Schmidt, 524 Commerce, Wichita, KS, 67202, US

(21) Appl. No.: 10/198,462

(22) Filed: Jul. 18, 2002

Related U.S. Application Data
(60) Provisional application No. 60/306,512, filed on Jul. 18, 2001.

(51) Int. Cl. H02K 1/00

(52) U.S. Cl. 310/40 R; 336/115

(57) ABSTRACT

The Static Generator is a pair of centerless, concentric counter-rotating donut forms which produce an electric current.

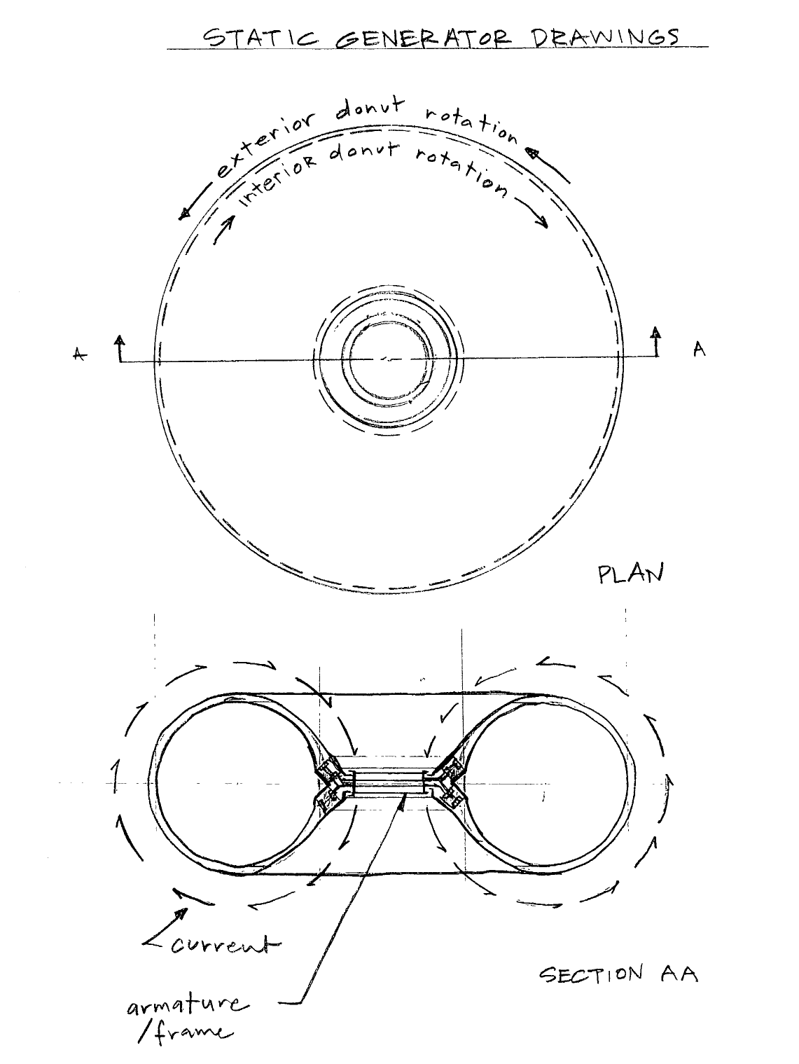

The Static Generator consists of two donut-like shapes, one within the other, like a tube within a tire. The two forms counter rotate, through the use of a bearing set and a driving force. The counter-rotation of the parts will produce an electric current which flows perpendicular to the radial centerline of the donut-like shapes. Thus, the flow of current passing through t5he donut hole will point the opposite direction as the current flow of the outer circumference of the donut. The motion of these parts will produce a magnetic field which will attract, repel, or accelerate other forms of matter.

Section AA shows armature with bearings; The driving force will mount to the armature and apply rotational force to the exterior donut. The bearings will subsequently rotate, causing the interior donut to be driven exactly the opposite direction as the exterior donut. The combination of rotational forces will then generate a flow of electrical current perpendicular to the rotation, denoted by arrows. Thus, a magnetic field to attract, repel, or accelerate other forms of matter.

What I claim as my invention is:

1. Two hollow donut forms; one indide the other, counter-rotating, to produce a mechanical magnetic field.
